(19) United States
(12) Patent Application Publication
(10) Pub. No.: US 2017/0046618 A1
(43) Pub. Date: Feb. 16, 2017

(54) ONTOLOGICAL SYSTEMS

(71) Applicant: Delonaco Limited, Nicosia (CY)

(72) Inventor: Valentyn Peltek, Zaporozhye (UA)

(73) Assignee: Delonaco Limited, Nicosia (CY)

(21) Appl. No.: 15/339,204

(22) Filed: Oct. 31, 2016

Related U.S. Application Data
(63) Continuation of application No. 13/759,598, filed on Feb. 5, 2013.

(51) Int. Cl. G06N 5/02; G06Q 30/06

(52) U.S. Cl. CPC G06N 5/02; G06Q 30/0631

(57) ABSTRACT

Ontological systems are created for a user and are used to provide numerous sets of user-experience elements such as customization of web products in visual appearance and functional content, user web interaction, marketing methods and pricing models, data processing and systematization, as well as recommendations of any sort.

### CROSS-REFERENCE TO RELATED APPLICATIONS

This application is a continuation of U.S. patent application Ser. No. 13/759,598, filed Feb. 5, 2013 and entitled “Ontological Systems,” which is hereby incorporated by reference herein.

### TECHNICAL FIELD

The present invention is directed to ontological systems, and more specifically to aspects of performing searches using ontological systems.

### BRIEF DESCRIPTION OF THE DRAWINGS

FIG. 1 illustrates a sample home page of an “Event Poster,” according to certain embodiments.

FIG. 2 is a high-level flow diagram that shows an ontological system is used for a sample project, according to certain embodiments.

FIG. 3 shows a sample social graph, according to certain embodiments.

### DETAILED DESCRIPTION

According to certain embodiments, ontological systems that is created for a user is used to provide numerous sets of user-experience elements such as customization of web products in visual appearance and functional content, user web interaction, marketing methods and pricing models, data processing and systematization, as well as recommendations of any sort.

Ontology is the set of the statements belonging to one user within one subject, incorporated with each other through objects. Ontological System's basic features include:
Automatic collection and classification of unique data.
Ensuring convenient information search for users.
Universal service for storage (input) of information and its convenient representation for users, including producers of the goods and services.
Tools for work with information.
Parsing of users' activities at introduction, search and information processing for drawing up of individual ontologies.

Mechanisms of an Ontological System include:
Collection and introduction of data in the system is realized through record of statements in the form of resource description framework (RDF) triplets, “object-property-value.”
Each element of the triplet registers as object in the table of objects.
Each statement is connected with the user who can be both the person, and the agent. At accession of the user to regional ontology both in case of existence of the statement and in individual and in regional ontologies, the statement is attributed to regional ontology, to be exact to the agent-user of this ontology.

Automatic analysis of statements include:
Identification the type of object (thing, event, concept).
Identification of synonyms.
Classification—belonging of object to the set of objects.

According to certain embodiments, Cluster (regional) ontology is comparison of ontologies of a great number of users within the concrete subject. In other words, the comparison includes the identification of common parameters by which users can be grouped. It is formed by the cluster agent who is the user of this ontology. Cluster ontologies can be as fixed (are defined by parameters of the agent), and operated by the user by change of level of completeness and compatibility with other ontologies.

According to certain embodiments, the Agent is the program which is carrying out any operations over statements. Agents can both cooperate with users (to be started on action of the user to do inquiries to the user), as well as be independent. Agents who write down the base statements (imported or generated on the basis of existing statements) have the status of the user.

According to certain embodiments, the system can be generally described as 1) a presentation medium by which each subject of system contains its set of true statements, that is different from some systems wherein true statements are the same (one) and applicable to all subjects of the system; 2) a User Centric (user-directed) Approach representation is based on the concept that each user has his/her own set of true statements which are true for him/her even if these statements do not coincide with generally accepted standards or statements; 3) a social graph application is representation of information to the search subjects. According to certain embodiments of the invention, not generally accepted assertions are considered valid. Assertions of specified subject (on the basis of subject's identity, types of relations and connections with other subjects) generate the user's ontology.

According to certain embodiments, the ontological system's areas of use include the following non-limiting examples (ontological system uses a structure similar to social graph): recommender system, predictive retail (demand stimulation), predictive retail (potential buyer), search system, dating, recruitment, time management system, production workflow efficiency system, news, dynamic homepage filling, and sites rating, which are described in greater detail herein.

### Recommender System (Engine)

According to certain embodiments, the recommendation engine is based on a search of comparison of user's ontologies and association of similar users into groups (clusters). The user gets recommendations with respect to a particular subject based on actions of other members of a group in which the user is clustered.

According to certain embodiments, the user gets recommendations based on the user's actions that have the most similar ontology to the actions of other users. The results can be outputted as goods, services and media which one user has already found/chosen based on another user's search criteria. Implementation include the following non-limiting examples:
Product recommendations (electronic online shopping, classifieds).
Media recommendations (music, movie, game, book recommendation systems).
Service recommendations (electronic shopping, classifieds).

### Predictive Retail: Demand Stimulation

According to certain embodiments, a system for demand stimulation in predictive retail is based on the user's ontology (including user's income level data, credit history, made purchases, as non-limiting examples) and the system offers to the user, for consideration, a various options for purchasing goods or services based on the user's ontological status.

Demand stimulation can include “pushing of goods and services” based on the statement that purchased goods of the user should conform to the user's income level. By analyzing the user's ontology, the system offers the user items (goods) that conform to the user's status which is unlike some systems that keep track of the user's search queries and the user gets context advertising only.

Some non-limiting examples include:
Using the demand stimulation method as one of the recommendation system elements. Demand stimulation can serve as a separate recommendation system, and as part of the global recommendation system.
Recommendations of goods on birthdays and other holidays based on search queries and the user's ontologies, with a purpose to help friends of the user select a gift for the user.

### Predictive Retail: Potential Buyer

According to certain embodiments, a predictive retail system with respect to a potential buyer is a system of matching (selection) a potential buyer (user) based on comparison of buyer's ontologies and goods, thus, helps to determine the most suitable goods for this buyer.

Also, by analyzing the user's actions and ontologies, the system can match goods that may satisfy the user's needs.

A non-limiting example includes using the “potential buyer” method as one of the recommendation system elements.

### Search System

According to certain embodiments, the search for information is based on the ontologies of each specific user or user groups (clusters), without binding to generally accepted arguments.

The social graph for a search is a representation based not on omniscience, but on statements, types of relations and connections with other Internet users.

The output of required information occurs not by generally accepted rating algorithms that sort platforms according to set of specified parameters (age, theme, trustworthiness, etc.), but by proceeding from statements that are true for particular user.

Some non-limiting examples include:
Output results of the search is based on an analysis of the history of successful search results of that of the user's friends.
Output results of search is based on an analysis of the history of successful search results of other users that belong to the same information group (cluster) as that of the user that is performing the search query.
Output results of search is based on an analysis of the history successful search results of similar users sorted by order of similarity to the user (comparing ontologies).
Output results of search is based on the user's connections+connections of his/her cluster, his/her friends.
Output results of search is based on actions which the user performs at a particular time of day. For example, a user may have a history of usually buying something from 13.00 to 19.00 and using entertainment resources from 10.00 to 13.00. Thus, the output of search results can be based on sorting results according to user's habits during such time periods.

### Dating

According to certain embodiments, an individualize dating system allows the inclusion of not only general data about a user (user's country, region, gender), but also the user's ontology (for example, tastes and preferences, past experience). On the basis such data, the system can propose candidates that have ontologies that are most similar to the user's ontologies as dating candidates for the user. This would increase the success of satisfying user's queries (demands).

The system can use a method of selecting a partner for the user (matching) based on a dating social graph and is performed by the comparing the user's ontologies by that of other users.

Some non-limiting examples where such a methodology can be used includes dating sites and social networks.

### Recruitment

According to certain embodiments, an employment assistance service is based on the ontology of each user that is applying for a particular job vacancy. The matching (selection) of vacancies to users/job candidates is based on the quality and experience of the user and/or based on the user's desires and preferences.

The method of matching job candidates (users) to job vacancies is based on creating user clusters that include data about place of employment and the requisite (professional) skills. When a user visits a job vacancy site, the system refers the user to a specified cluster and the system outputs a list of vacancies (provides job) based on the user's personal ontologies and ontologies of the user cluster to which user belongs.

Thus, the method of matching job candidates (users) to job vacancies can be based on the user's ontology (for example, list of job skills, professional experience, knowledge and abilities). Such a service not only proposes suitable job vacancies, but also can advise on development of certain skills for getting desirable job.

Some non-limiting examples where such a methodology can be used includes job placement sites (sites of employment) and social network services such as LinkedIn.

### Time Management System

According to certain embodiments, a time management system can be based on the employee's ontology (for example, his/her Internet activity, his/her interaction with other users, visited platforms (sites) and time spent on each process). Such a system can make recommendations for improving work efficiency.

Such a system can be based on the user's ontologies and his/her interactions with other users. Knowing the characteristics of each employee, it may be possible to improve (increase) effectiveness his/her work. Such a system can provide a service for assessment effectiveness of a user's time (for example, an employee).

### Production Workflow Efficiency System

According to certain embodiments, a production workflow efficiency system can provide recommendations for increasing of work efficiency of individual employees or of the Company as a whole. This may be done by analyzing the ontology of the employee, the department or the Company as a whole. Such a system can be used to reveal weaknesses of workflow processes and can provide recommendations to eliminate such weaknesses.

According to certain embodiments, the system uses a method to effectively organize a working process by calculating the employee's ontology or user cluster (department, Company, Holding company), which includes list of execution of tasks, data of resource allocation and efficiency indexes of work. On the basis of existing data, the system provides recommendations for optimization of the user's work or user cluster.

### News

According to certain embodiments, a news service can be based on a social graph that allows for the reporting news in terms of each user's ontology, user cluster for certain types of news, rather than opinions of publications, TV channels or news editor's points of view (opinions).

Such a service provides news based on the user's ontology without associating to political, social, cultural and other generally accepted arguments. Instead the system uses one or more important statements of the particular user or user-joined groups, in addition to specified cluster's parameters.

Such a news presentation method is based on the postulate that each user (user group) has his/her own set of true statements which could be different from the generally accepted code of practice. For example, such a news service allows for the reporting of all point of views on a specified event or news, rather than just the opinion of the author of the article or publication.

### Dynamic Homepage Filling

According to certain embodiments, a method of matching the most interesting and appropriate platforms for filling a start page (home page) of a particular user can be based on the user's ontology which includes the user's interests and activities data in the Internet. The start page (home page) can be varied according to changes in the user's ontology.

Changes to user's start page can occur automatically on basis of the user's ontology, entry into specified users' clusters, for example. Another example where such a system can be used is as a plug-in for search systems (engines) which will generate sites for the particular user's homepage.

### Sites Rating

According to certain embodiments, a system for rating sites can be based on a social graph that allows for the allocation of the sites positions not under a set of parameters that are generally accepted by search systems (age, theme, trustworthiness, etc.), but based on the user's ontology (for example, user's search history, interests and hobbies).

Such a method of personalizing the rating of sites is based on statements associated with each user's set of arguments, interests and hobbies, which constructs the user's ontology. Thus, the search will output sites that fit for user's ontology. Some non-limiting examples where such a system can be used include as a plug-in for search systems (engines) will make possible for a user to receive personalized rated sites in search results, the blocking of adult sites for minors in search results, and as one element of a recommendation system.

### “Local Affiche”

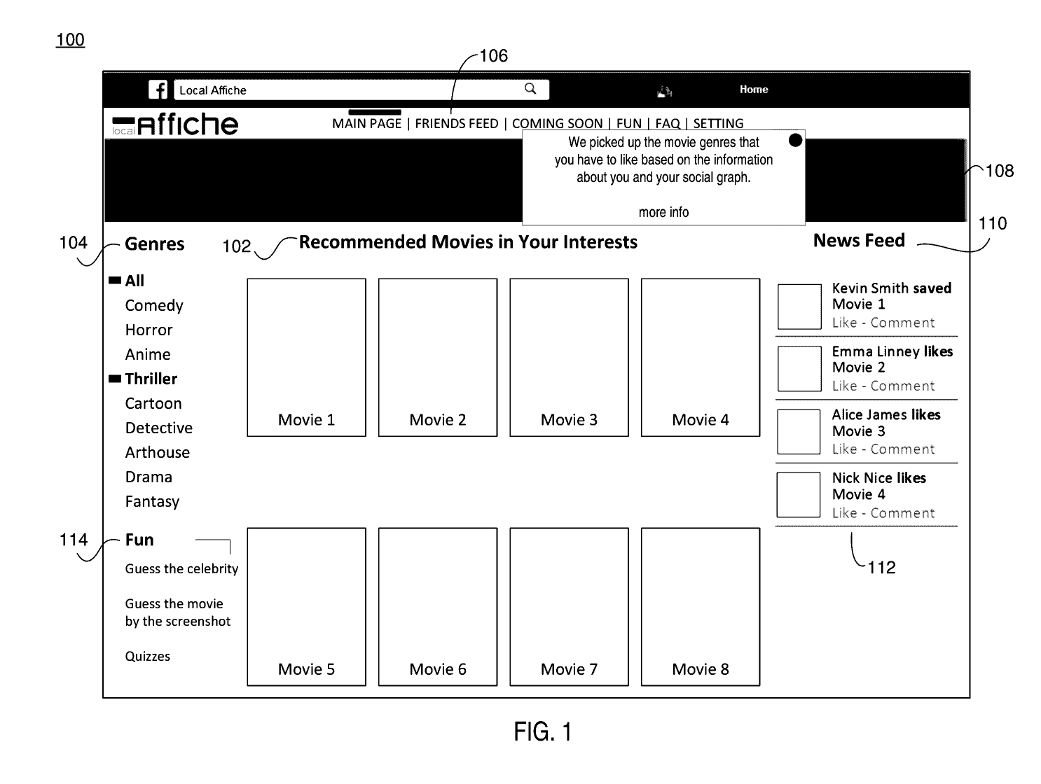

The ontological system described herein can be used for an event poster project, as a non-limiting example. “Local Affiche” is a widget for a social networking site such as Facebook, where movies are displayed based on identification of a particular user's criteria by comparing the material and spiritual axioms of people. FIG. 1 illustrates a sample home page of “Local Affiche” 100. FIG. 1 also shows “recommended movies 102 for the user as determined by the ontological system for the Local Affiche project, movie genres 104, a Friends Feed 106, a “invite friends” button 108, a news feed 110, friends actions 112 shown in news feed 110, and a Fun section 114.

The objectives of an event poster can include the following:
Obtaining of information of users in the social network (such as Facebook) with further application of this data in other ontological projects. Since Facebook is one of the largest social networking websites in the world, it is one of the most complete sources of data about users.
Use of Social Graph as a mechanism for motivating users to act.
Automatic provision of personalized recommendations to the user. This allows the user to save time in searching for information he/she needs to find.
Testing of the idea of ontological systems, practical application of all ideas and products on interaction of the ontological core with the project.

The general functionalities of the “Local Affiche” widget can include:
Provision the list of movies first of all by user's genres of movies which were revealed from his axioms, the social graph and clusters, other movies will be displayed with lower priority.
Allowing movie search by the name, year of release, the actor and the director.
Allowing movie search by genre.
Possibility of providing the recommendation to friends to watch/not to watch the movie.
Allowing a user to view friends' actions within the application in Friends feed.
Allowing a user to view friends' favorite movies in Friends feed.
Allowing a user to buy tickets through partner websites.
Allowing a user to watch movies online through partner websites.
Allowing a user to express an opinion (the review, the comment) about the movie.
Allowing a user to estimate the movie.
Allowing a user to receive notices about movie premieres.

The “Local Affiche” widget can include the following features:
Identification of favorite movie genres of the user who entered the widget without any questioning and necessity to select genres manually.
Use of Social Graph as a mechanism for motivating users to act. The results displayed will also be affected by data of user's friends such as information of movies they like, movies they discuss. This can motivate a user to act. For example, if many friends like a certain movie, the user may wish to watch that movie.
A user of the project can be evaluated based on a material and spiritual perspective. Material and spiritual axioms can be stored in glossaries and can be static statements. Search of the most suitable results for the user will be made on the basis of comparison of user's data with these axioms.

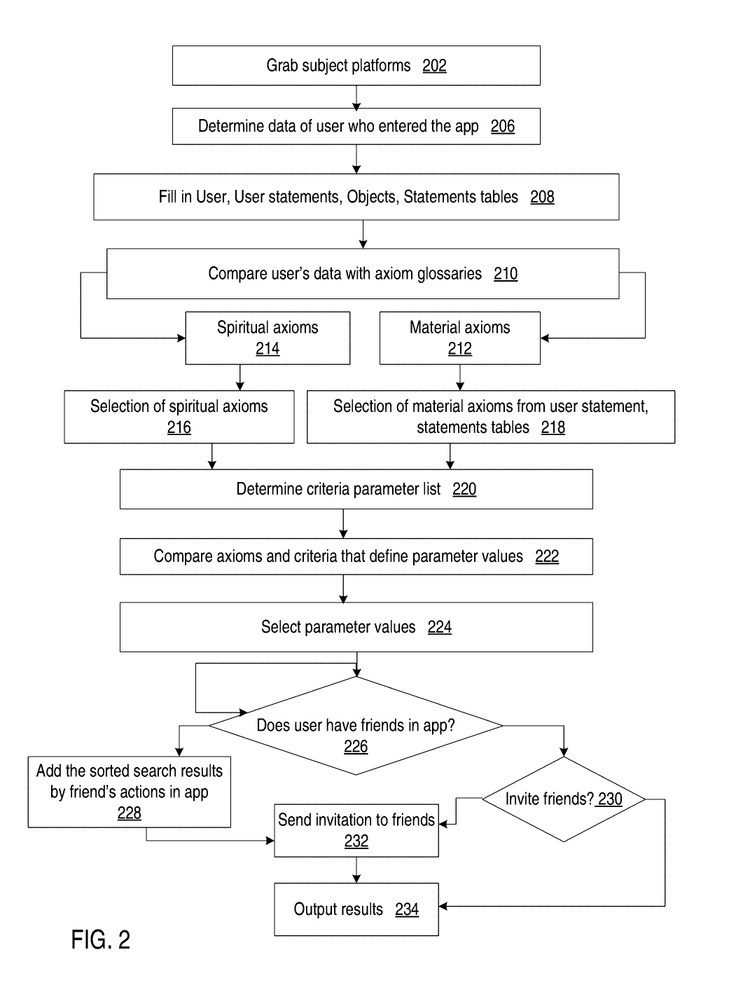

FIG. 2 is a high-level flow chart that describes an ontological system project. In FIG. 2, at block 202, the system grabs thematic resources (resources on concrete subjects such as entertainment, events, etc. if the project is a movie event poster). Block 202 is for filing in/populating the core ontological data for the user and is common to most projects of ontological systems.

At block 206, the data of the user that has entered the application (for example, event poster application) is determined (data from the social network such as the collection of public data about the user in the social network API, e.g., Facebook public data on the user).

At block 208, all data filled in by a user on his/her page in the social network site (e.g. Facebook) is transmitted into the ontological core. The obtained objects and statements will be added into the “User,” “User statement,” “Objects,” and “Statements” tables. Such information includes statements made by the user (city of residence, date of birth, gender etc.), data on user's behavior on the social networking site, user's social graph etc. Glossaries of spiritual and material axioms are filled in by filling in tables for the user, user statements, objects, and statements using the data grabbed from the thematic resources. For example, software agents take the grabbed information and fill into the “User,” “User statement,” “Objects,” and “Statements” tables. Spiritual axioms are parameters by which one can determine character and temperament of the user (for example, one can connect date of birth of the user to his/her temperament). Material axioms are one of many types. One example is the level of the income of a person. The system can compare data on a position of the user and his location to statistics of salaries in this region. Blocks 206 and 208 are common to most projects of ontological systems.

At block 210, the user's data is compared to the axiom glossaries which include comparing user's data against spiritual axioms at block 214 and comparing user's data against material axioms at block 212. For example, the statements received from the user (known information about the user such as gender, birth date, city of residence, occupation, information that is available, social networks, social graphs, user internet behavior, etc.) are compared to the spiritual and material axioms in the core ontological data for the particular user. A non-limiting example of comparing user data with axiom glossaries in the core ontological data is as follows. The software agent(s) of a logical conclusion is created. The agent(s) will compare axioms with data about the user and draw a conclusion about character/profile of the user, the user's level of income, psychological type, temperament etc. The resulting profile of the user (for example, the user is profiled as a sanguine person with an income of $30000 per year) is associated with a cluster. In this case the cluster is a group of people with identical or substantially similar axioms. Such a cluster will associate all sanguine persons with level of the income of $30000 a year, as an example.

At block 216 spiritual axioms are selected and at block 218 material axioms are selected for the user. The list of suitable spiritual and material axioms is selected on the basis of data intersections. A non-limiting example of a data intersection on the basis of which axioms for the user are defined is the definition of a zodiac sign of the user using the user's date of birth. By zodiac sign, the system can determine the type of temperament of the user. This is one of the large number of ways that the axioms can be defined for a user based on comparing with the user data.

At block 220, a criteria parameter list is determined based on the subject matter or goal of the project. The criteria parameter list are axioms that are associated with the subject matter or goal of the project. At block 222, the criteria parameter list is compared to the relevant axioms. Relevant axioms are ones that can affect the recommendation result of a current project. For example, for “Local Affiche” project, the axioms that can make results more relevant for movies will be selected. For example, the selected axioms can be of the following non-limiting examples, “Does not like horror movies,” “Likes action movies.” The criteria parameter list related to the subject of event poster for movies can be location of the cinema, movie genre, movies that user's friends have already seen, as non-limiting examples. Favorite color or favorite food axioms are not likely to be appropriate for the “Local Affiche” project.

At block 224, parameter values are selected. The static parameters associated with the project (example for “Local Affiche,” the parameters include genre of a movies, names of actors and directors) will be compared with the relevant axioms obtained from above steps. The resulting parameter values that correspond with the greatest number of axioms get the highest ranking and are selected.

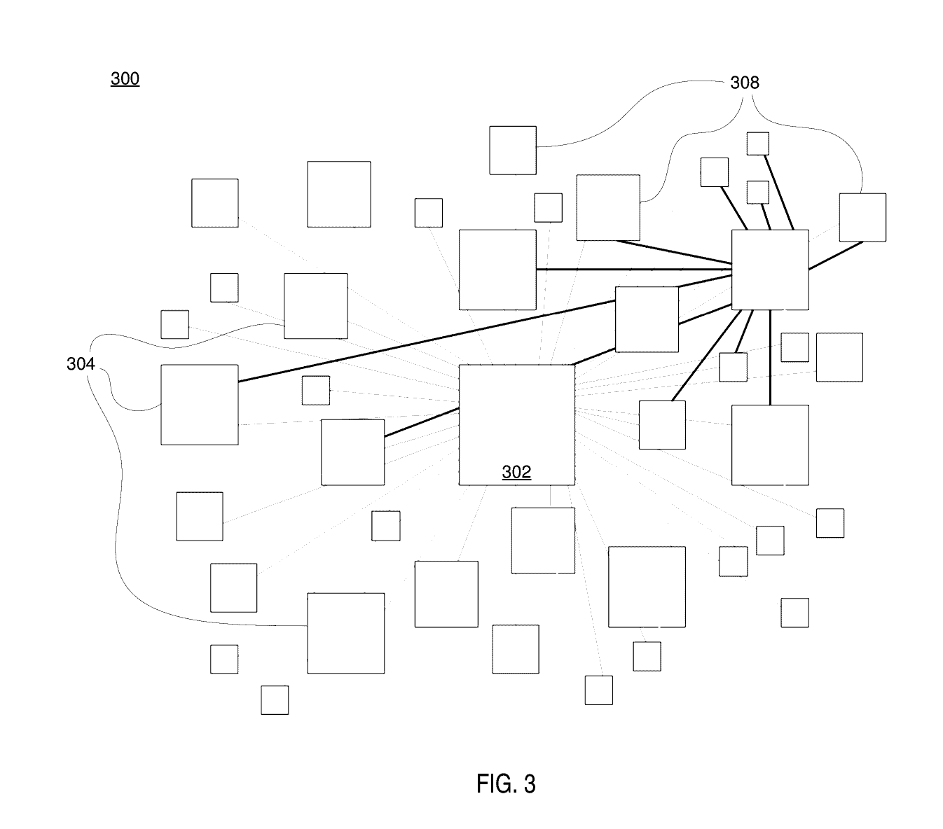

At block 226, the user's social graph (see FIG. 3, for example) is used to determine the user's friends that are in the application (for example, the event poster application).

If the user has friends in the application, then at block 228, the search results from block 224 are added to actions of his/her friends (such as “likes,” “share,” interest in some objects, etc.) in the application (movies added to the Friends Feed, comments, shared events). User always can invite friends at block 232. Also, if at block 226, it is determined that the user has no friends in the application, then the user can invite friends at block 232.

If one of the user's friends does not use the application, the results are displayed on the basis of data about the user and he always can invite friends to the application.

At block 234, the results are obtained and presented to the user. For example, in the “Local Affiche” project, the user is presented with movies that are based on the user's spiritual and material axioms.

If the “Friends feed” is empty, there are 2 variants—user's friends do not use the app, or none of his friends have added anything into his/her Friends Feed (friends action displaying and movies that friends are interested in). In such case, the user can be motivated to act if the following things are displayed on user's Friends Feed page:
“Haven't your friends joined you in this app yet?” and the “Invite friends” button.
“Your friends do not plan to go anywhere. Don't let them miss the most interesting—invite them to interesting events.”

According to certain embodiments, the user can subscribe to be informed about beginning of sales of tickets for the movie, the appearance of a movie in online cinema.

According to certain embodiments, the user will have an opportunity to invite/recommend friends to watch or not to watch current movie.

According to certain embodiments, the user will have an opportunity to share the event on his/her wall.

According to certain embodiments, while clicking the “Like,” “Unlike,” “Rate” button under the movie, the notice that the user has liked, unlike, shared or rate that movie appears on his/her wall.

According to certain embodiments, while the user adds a comment or review for the movie, the app displays it on the user's wall.

According to certain embodiments, user can play in mini-games, related to movies, take quizzes, create quizzes and movie quotes, and communicate in groups.

According to certain embodiments, users can make movie ratings by themselves. The marks can be added into the News Feed and his/her friends' Friends Feed so that the user can see the movies rated by his/her friends.

FIG. 3 is a sample graphical illustration of a social graph model 300 for user 302. FIG. 3 shows user 302 in relation to user friends 304 and the friends 304 connection with other friends 308.

In the foregoing specification, embodiments of the invention have been described with reference to numerous specific details that may vary from implementation to implementation. Thus, the sole and exclusive indicator of what the invention is and what is intended by the applicants to be the invention, is the set of claims that issue from this application, in the specific form in which such claims issue, including any subsequent correction. Any express definitions set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer method comprising:
determining data of a user that is using a particular application;
comparing the data of the user with a spiritual axiom glossary and a material axiom glossary;
selecting a set of spiritual axioms and a set of material axioms for the user;
determining a criteria parameter list for the user based on the application;
comparing the selected set of spiritual axioms and the selected set of material axioms with the criteria parameter list;
from the criteria parameter list, selecting a set of parameter values that corresponds to a greatest number of spiritual axioms and material axioms from the selected set of spiritual axioms and the selected set of material axioms;
determining the user's friends in the application;
adding actions performed by the user's friends in the application to the set of parameter values; and
displaying the parameter values as output results.

2. The method of claim 1, further comprising making one or more recommendations comprising any of: product recommendations, media recommendations and service recommendations.

3. The method of claim 1, further comprising customizing solutions in one or more systems comprising: pricing models, data processing, data systemization, user web interaction, predictive retail in demand stimulation systems, predictive retail for potential buyer systems, search systems, dating systems, recruitment systems, time management systems, production workflow efficiency systems, news systems, dynamic home page creation systems, website rating systems, and event poster systems.

4. The method of claim 1, further comprising populating core ontological data for the user.

5. The method of claim 1, further comprising creating material axioms glossaries.

6. The method of claim 1, further comprising creating spiritual axioms glossaries.
